(19) United States
(12) Patent Application Publication
(10) Pub. No.: US 2006/0291685 A1
(43) Pub. Date: Dec. 28, 2006

(54) Adjustable headset structure

(75) Inventor: Ching-Tsai Chou, Mei-Shan Village (TW)

Correspondence Address: BACON & THOMAS, PLLC, 625 SLATERS LANE, FOURTH FLOOR, ALEXANDRIA, VA, 22314, US

(73) Assignee: AirDigit Incorporation, Hinch City (TW)

(21) Appl. No.: 11/147,273

(22) Filed: Jun. 8, 2005

(51) Int. Cl. H04R 25/00

(52) U.S. Cl. 381/381

(57) ABSTRACT

An adjustable earplug-type headset is provided. The headset mainly contains a body member whose inner side is configured with an earphone and a positioning track. A positioning device is configured on an adjusting member, which in turn is slidably installed inside the positioning track. The positioning device helps to position the headset steadily and reliably on a user's outer ear when it is stuck in an appropriate location within the user's outer ear. The distance between the positioning device and the earphone could be adjusted by each individual user to fit his or her ear's specific characteristic. The adjusting member contains spring elements to lock the adjusting member and the positioning device to the positioning track by configuring corresponding and matching geometrical shapes along the surfaces where the spring elements and positioning track interface with each other.

### BACKGROUND OF THE INVENTION

1. Field of the Invention

The present invention generally relates to headsets, and more particularly to a earplug-type headset having a positioning device for steadily and reliably fixing the headset to a user's outer ear.

2. The Prior Arts

Due to the recent widespread popularity of mobile communications devices, headsets, despite an old technology, have regained their spotlight. In order achieve lighter weight and more comfort, recent headsets for the mobile communications devices are commonly designed for use on a user's single ear. These single-ear headsets usually contain an earpiece and an ear loop for hanging on the user's outer ear and fixing the earpiece tightly to the user's cheek. Headsets with ear loops are usually used for either left or right ear but not both. In addition, once the loop is broken, the headsets become useless even though the earpiece is perfectly intact. Another type of the single-ear headsets is the earplug-type headset. As illustrated in FIG. 1, the earplug-type headset contains a body member 40 and an earphone 41 for insertion into the user's external auditory canal. The earplug headset could be used on the user's left or right ear and there is no ear loop broken problem. However, the earplug-type headset has no positioning device other than the earphone 41 itself. Therefore, when the user is walking or running, it would be difficult to keep the body 40 tightly close to the user's cheek. In addition, the instability of the body 40 would cause uncomforting feeling to the user's ear and noises to reduce the headset's reception quality.

### SUMMARY OF THE INVENTION

Accordingly, the present invention discloses an adjustable headset structure so as to obviate the problems associated with the positioning of the conventional earplug-type headsets.

The headset according to the present invention mainly contains a body member whose inner side is configured with a earphone and a positioning track between the earphone and the top of the body member. A positioning device is configured on an adjusting member, which in turn is slidably installed inside the positioning track. The positioning device helps to position the headset steadily and reliably on a user's outer ear when it is stuck in an appropriate location within the user's outer ear. The distance between the positioning device and the earphone could be adjusted by each individual user to fit his or her ear's specific characteristic. The adjusting member contains spring elements to lock the adjusting member along with the positioning device to the positioning track by configuring corresponding and matching geometrical shapes along the surfaces where the spring elements and positioning track interface with each other.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a perspective view showing a conventional earplug-type headset.

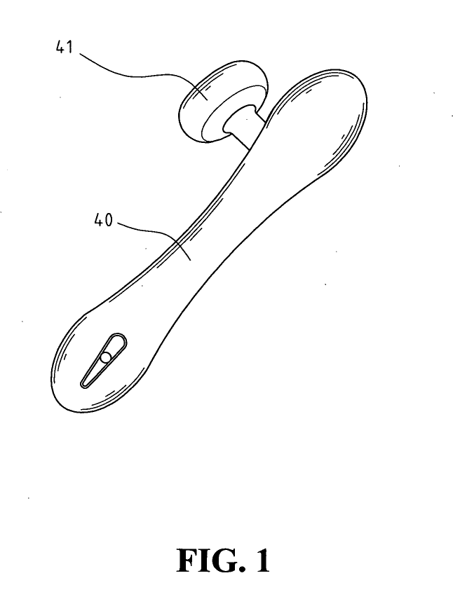

FIG. 2 is a perspective view showing the assembly of a headset according to the present invention.

FIG. 3 is a perspective view showing a headset according to the present invention.

FIG. 4 is an enlarged perspective view showing the assembly of a headset according to the present invention.

FIG. 5 is an enlarged perspective view showing a section of a headset according to the present invention.

FIG. 6 is schematic view showing a headset according to the present invention is worn by a user.

FIG. 7 is an enlarged view showing how a headset according to the present invention is fit within a user's outer ear.

### DETAILED DESCRIPTION OF THE PREFERRED EMBODIMENTS

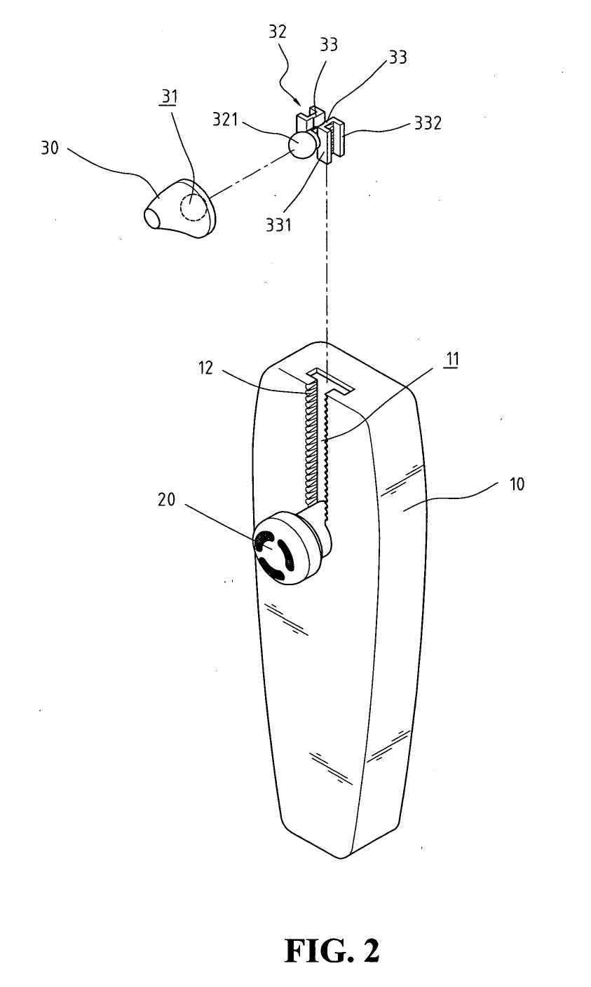

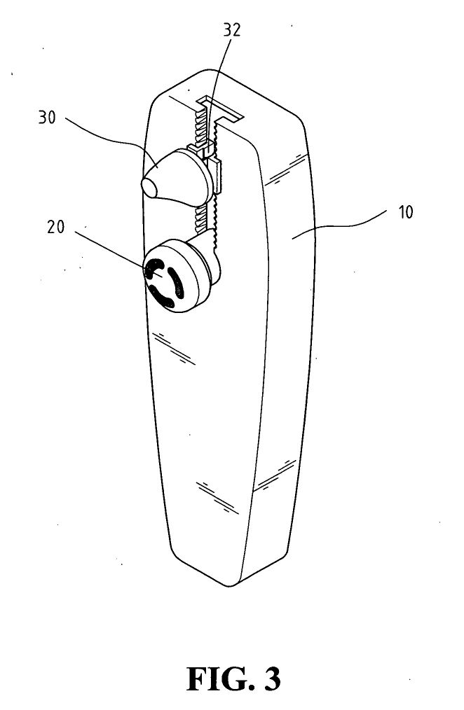

As illustrated in FIGS. 2 and 3, the present invention mainly contains a body member 10, an earphone 20, and a positioning device 30.

The body member 10 has an elongated and flat form factor. The earphone 20 is located on a side of the body member 10. On the same side, there is a positioning track 11 opening up a slot ranging from an end of the body member 10 to the earphone 20. Along the slot walls, there is a plurality of bulges 12 forming a roughly zigzag surface. The side of the body member 10 where the earphone 20 and the positioning track 11 are located is referred as the inner side hereinafter. The inner side of the body member 10 is also the side facing and touching the user's cheek. The end of the body member 10 where the positioning track 11 begins is referred as the top end hereinafter.

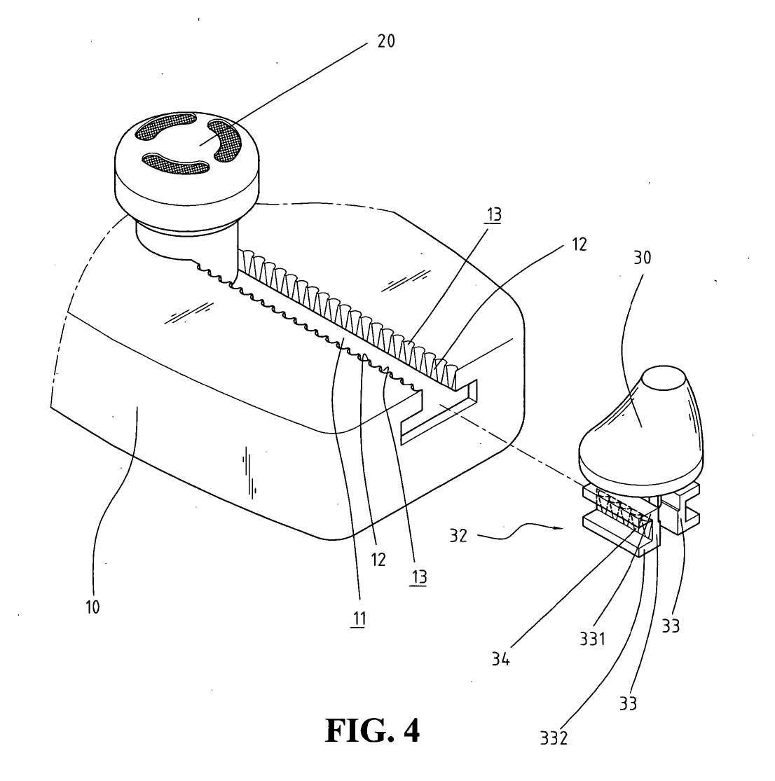

The positioning device 30 is a solid member made of a flexible material and has a flat-topped cone shape with a slightly curved side. The positioning device 30's bottom has an opening 31 for locking to a joining element 321 of an adjusting member 32. The adjusting member 32 further contains at least two spring elements 33. Each of the spring elements 33 has two side walls 331 and 332, forming an open trough therebetween. Along the bottom of the open trough, there are a plurality of bulges 34 forming a roughly zigzag surface (please also see FIG. 4). The spring elements 33 are joined together back to back roughly in parallel with their open troughs face toward opposite directions and with the joining element 321 interposed therebetween. The top end of the spring elements 33 could be closed in toward each other but their counter spring forces would return them to their original distance.

The adjusting member 32 is installed in the positioning track 11 by closing the top ends of the two spring elements 33 by hand toward each other, inserting the adjusting member 32 into the positioning track 11 via its top opening (not numbered), and then releasing the two spring elements 33. For each of the spring elements 33, the two side walls 331 and 332 wrap around the slot wall of the positioning track 11 and the bulges 34 at the trough bottom are at close contact with the bulges 12 along the slot wall. The adjusting member 32 could be slid along the positioning track 11 so that its distance from the earphone 20 could be adjusted. Once at a desired location, the adjusting member 32 (along with the positioning device 30) would be steadily held at that specific location by the spring forces of the spring elements 33.

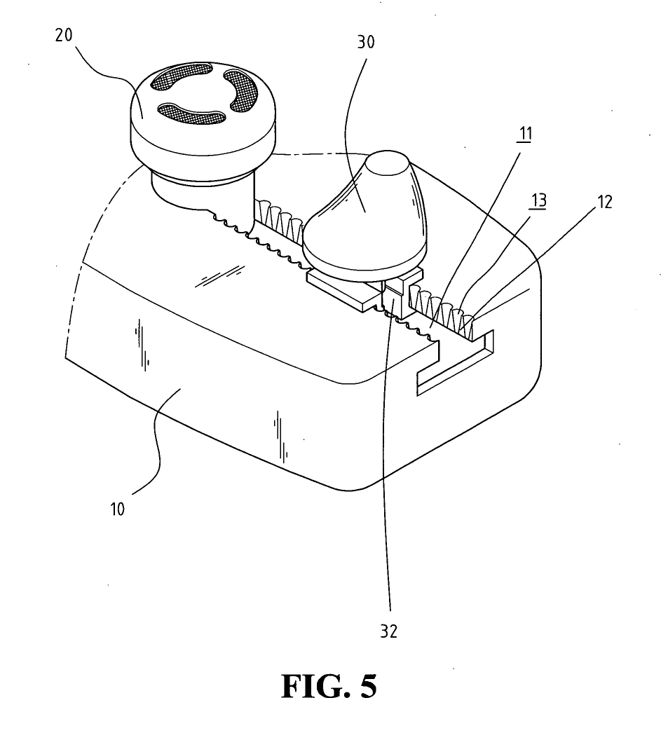

Please refer to FIGS. 4 and 5. To further improve the steadiness of the positioning device 30 and the adjusting member 32, the present invention configures the bulges 12 along the slot walls of the positioning track 11 to have their protrusion gradually increased from one end to the other end. On the other hand, the bulges 34 along the toughs of the adjusting members 32 are configured to have their protrusion gradually decreased from one end to the other end (i.e., opposite protrusion arrangement). As such, the bulges 12 and 34 could be interlocked together.

Other forms of embodiment of the bulges 12 and 34 are also possible. For example, in the present embodiment, the bulges 34 have a semi-circular cone shape while the bulges 12 are actually formed by concaves 13 having a matching, concaved semi-circular cone shape.

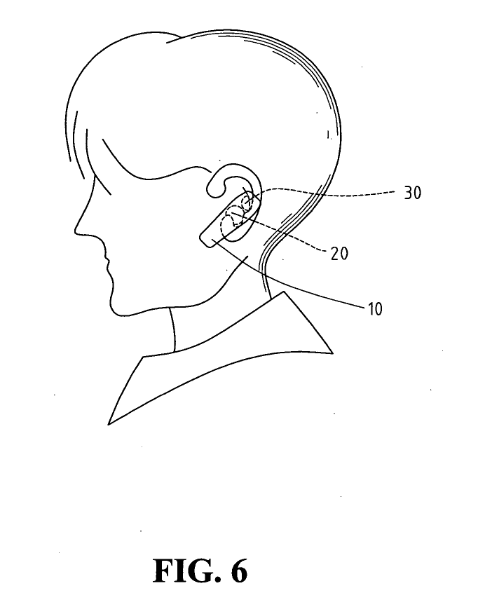

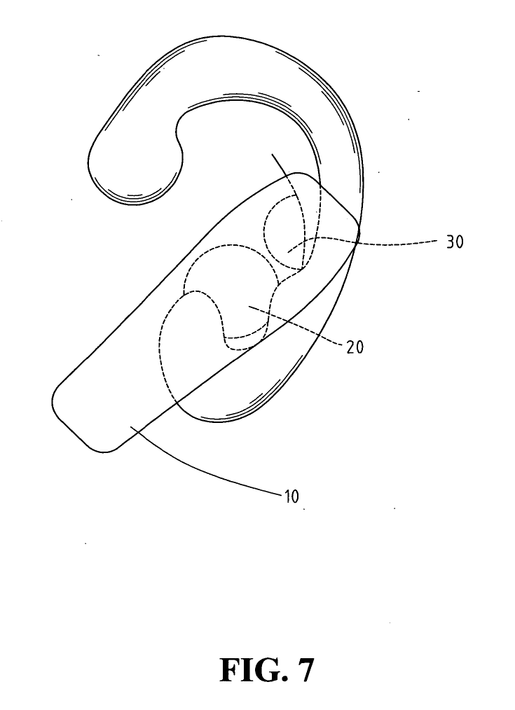

Please refer to FIGS. 6 and 7. To use a headset according to the present invention, first, the location of the adjusting member 32 is adjusted so that its distance to the earphone 20 is roughly equal to or slightly larger than the distance between the user's external auditory canal and earlobe. Then, the earphone 20 is inserted into the user's external auditory canal and the positioning device 30 could be stuck in an appropriate location, for example, in the gap between the helix and antihelix of the user's outer ear. If required, some slight adjustment of the location of the adjusting member 32 could be performed (without taking off the headset) so as to achieve a steady and reliable positioning of the headset.

As can be seen from the foregoing description, due to it symmetrical design, a headset according to the present invention could be directly used on either left or right ear of a user without adjustment (except that some slight adjustment of positioning device 30's location may be required).

As can also be seen from the foregoing description, the present invention allows each individual user to adjust the positioning device 30's location to suit his or her specific ear characteristic so as to achieve the maximum comfort.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An adjustable headset comprising a body member, an earplug-type earphone, and a positioning device, wherein
said earphone is located on an inner side of said body member;
said body member has an elongated and flat form factor and a positioning track opening up a slot on said inner side, said slot has a plurality of first bulges along the surface of a slot wall;
said positioning device is joined to an adjusting member;
said adjusting member contains at least a spring elements having a plurality of second bulges formed on a surface; and
said adjusting member is slidably installed inside said positioning track with said second bulges interfacing with said first bulges so as to provide steady positioning of said adjusting member and said positioning device attached to said adjusting member.

2. The adjustable headset structure as claimed in claim 1, wherein said positioning device is a solid member made of a flexible material and has a flat-topped cone shape with a slightly curved side.

3. The adjustable headset structure as claimed in claim 1, wherein said positioning device has an opening for locking to a joining element of an adjusting member.

4. The adjustable headset structure as claimed in claim 1, wherein said spring elements contains two side walls forming a trough therebetween, said second bulges are configured on the bottom of said trough, said side walls wrap around said slot wall of said positioning track's slot, a spring force of said spring element presses said bulges against said first bulges.

5. The adjustable headset structure as claimed in claim 1, wherein said first bulges have the protrusion gradually increased from one end to the other end while said second bulges have corresponding but opposite protrusion arrangement so that said first and said bulges interlock with each other when they are interfaced.

6. The adjustable headset structure as claimed in claim 1, wherein said first bulges have a semi-circular cone shape while said second bulges are formed by a plurality of concaves having a matching, concaved semi-circular cone shape.
